(19) United States
(12) Patent Application Publication
(10) Pub. No.: US 2012/0286065 A1
(43) Pub. Date: Nov. 15, 2012

(54) ROTARY SPRAYING DEVICE

(75) Inventor: WEI JEN LIN, Taipei City (TW)

(73) Assignee: STRONG FORTRESS TOOL CO., LTD., Taipei City (TW)

(21) Appl. No.: 13/172,486

(22) Filed: Jun. 29, 2011

(30) Foreign Application Priority Data
May 11, 2011 (TW) 100116559

(51) Int. Cl. B05B 3/02

(52) U.S. Cl. 239/225.1

(57) ABSTRACT

Disclosed is a rotary spraying device in which a fluid tube is assembled with a rotary means formed to have a channel structure. A portion of a fluid which flows through the fluid tube flows into the rotary means so as to provide a rotation applying force for rotating the rotary means when the fluid flows through the channel structure in the rotary means. Thus, the fluid is sprayed rotatably from the fluid tube which is rotated with the rotary means.

### FIELD OF THE INVENTION

The present invention relates to a spraying gun, and more particularly to a rotary spraying device driven by a rotary means thereof.

### BACKGROUND OF THE INVENTION

Many spraying guns have been used widely for cleaning dust and dirt from a surface of an object, for watering, for spraying paint, and the like. The spraying guns remove dust and dirt by spraying a high pressure fluid, and perform watering and spraying paint with the use of a high pressure fluid mixed with water or other spraying liquid.

In order to uniform the spraying distribution, the spraying gun is manufactured to have a spraying tube with a bending shape and a rotating device is provided to couple with the spraying tube of the spraying gun. When rotating the spraying tube by the rotating device, a mixed fluid of a high pressured gas and a spraying liquid can be sprayed out in e in every direction with the rotation of the spraying tube. For example, the rotating device may be a fan having a plurality of fan blades, so as to be rotated by turning, by the high pressured gas introduced into the spraying gun, the fan blades. Alternatively, the rotating device may be a motor which is driven by power supplying, so as to make the spraying tube rotating.

However, because the fan blade has complicated structure and has low structural strength, the rotating device, which is a fan, is more difficultly in manufacturing and miniaturizing, and is easily damaged and deformed. The motor needs power supplying for operation so the rotating device wastes in production cost and power consumption.

### SUMMARY OF THE INVENTION

In view of the above circumstances, the spraying tube is rotated by a fan or a motor according to a prior art of the spraying gun, so that the spraying gun is difficult in manufacture and costly in production.

Therefore, it is an object of the present invention to provide a rotary spraying device with stronger structure which is also easy in manufacturing and is stable in rotating.

The present invention overcomes the drawbacks of the prior art, and provides a rotary spraying device comprising: a fluid tube provided at one end thereof with a fluid inlet and the other end thereof with a spraying outlet, and a through hole provided on tube wall of the fluid tube; a rotary means, coupled with the fluid tube, provided with a drive wall inclining to a fluid output direction of the through hole and an out flow passage formed at an end of the drive wall, where the drive wall is driven and pushed by a force of fluid output from the through hole via a fluid connection by a flow space; and a conveying tube provided at one end thereof with a fluid container inlet for connecting to a fluid container, and the other end thereof being disposed within the fluid tube to extend to the spraying outlet of the fluid tube.

In a preferred embodiment of the present invention, the drive wall of the rotary means is formed extending along an involute curve.

In a preferred embodiment of the present invention, the rotary means is further provided with a plurality of fastening ribs extending toward the fluid tube.

In a preferred embodiment of the present invention, the rotary means includes a front fastening layer, a back fastening layer, and a flow channel layer disposed therebetween. Besides, said front fastening layer and said back fastening layer are made of a rigid material and said flow channel layer is made of a plastic material.

In a preferred embodiment of the present invention, the fluid tube is further provided inside with a splitter for splitting the fluid flowing through the fluid tube into two portion, wherein one portion of the fluid flows toward the spraying outlet of the fluid tube and the other portion of the fluid flows toward the through hole of the fluid tube.

In a preferred embodiment of the present invention, the conveying tube is further provided inside with a flow rate regulating means including a water stopper and a seal member, the water stopper is formed with a flow hole and the seal member is formed at one end thereof with a sharp section movably disposed in the flow hole of the water stopper.

In a preferred embodiment of the present invention, the rotary spraying device further comprising a rotation speed adjusting means including a first adjusting member and a second adjusting member, wherein the first adjusting member is connected with the outflow passage of the rotary means and has an outlet surface formed with a plurality of first openings and the second adjusting member has an inlet surface coupled with the outlet surface of the first adjusting member to rotate with first adjusting member, and the inlet surface is formed with a plurality of second openings corresponding to the first openings.

Thereby, the fluid tube can be rotated without power supplying. The rotary means is stronger in structure and is easy in miniaturizing because the drive wall, the outflow passage, the flow space and so on are formed inside the rotary means. Further, the rotary means having such structure can be stable in rotating and rotate uniformly in high speed with low variation, and those effects are good for fluid spraying.

### BRIEF DESCRIPTION OF THE DRAWINGS

The structure and the technical means adopted by the present invention to achieve the above and other objects can be best understood by referring to the following detailed description of the preferred embodiments and the accompanying drawings.

FIG. 1 is a perspective view illustrating an embodiment according to the present invention;

FIG. 2 is a cross-section view of FIG. 1;

FIG. 3 is a partial enlarged view of FIG. 2;

FIG. 4 is a perspective view illustrating a rotary means;

FIG. 5 is a cross-section view of the rotary means;

FIG. 6 is a cross-section view of a flow rate regulating means;

FIG. 7 is a perspective view illustrating a rotation speed adjusting means; and

FIG. 8 is another perspective view illustrating the rotation speed adjusting means.

### DETAILED DESCRIPTION OF THE PREFERRED EMBODIMENTS

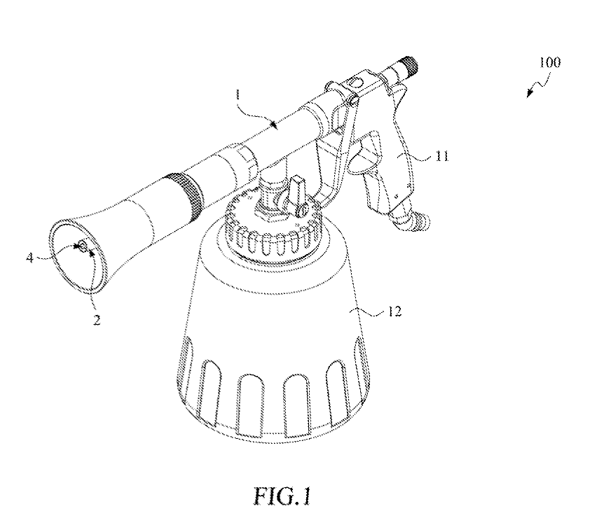

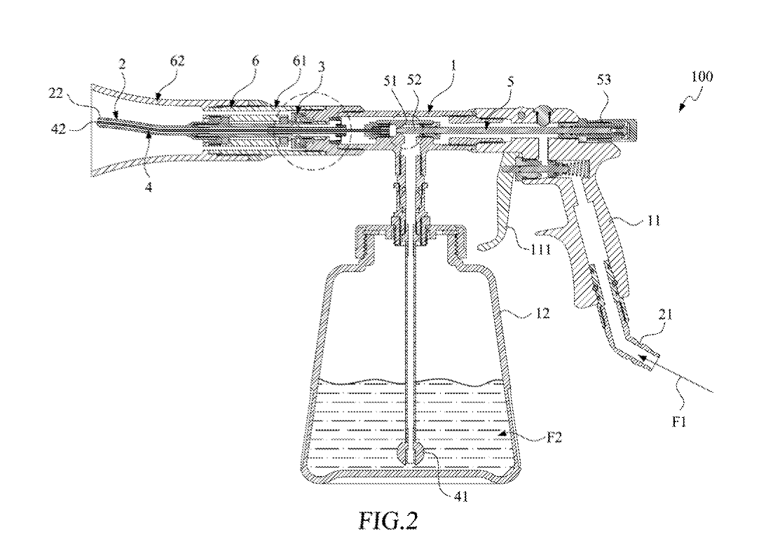

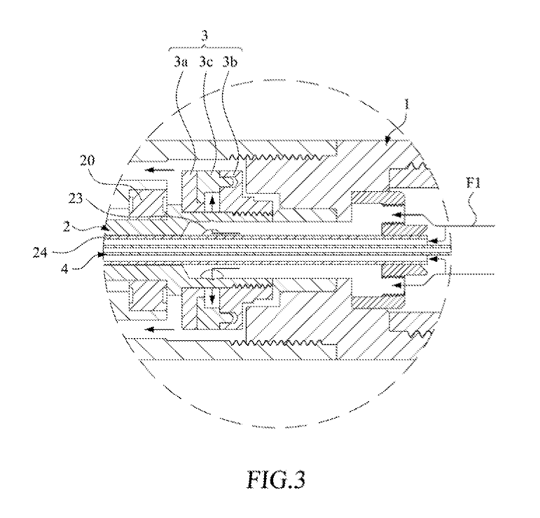

Please refer to FIGS. 1-3. FIG. 1 is a perspective view illustrating an embodiment according to the present invention, FIG. 2 is a cross-section view of FIG. 1, and FIG. 3 is a partial enlarged view of FIG. 2. According to an embodiment of the present invention, a rotary spraying device 100 comprises a body 1 provided at an end thereof with a control handle 11 and a lower portion thereof with a fluid container 12.

A fluid tube 2, which is provided in the body 1, is assembled to the body 1 with a bearing 20, so as to rotate with an axial of the fluid spraying device 100. The fluid tube 2 is provided at one end with a fluid inlet 21 extending within the control handle 11. The other end of the fluid tube 2 is provided with a spraying outlet 22 extending to an opposite side of the body 1. A fluid F1 input from the fluid inlet 21 will be output from the spraying outlet 22.

Further, a rotary means 3, provided in the body 1, is coupled with the fluid tube 2, so that the fluid tube 2 can be rotated with the rotary means 3 together to process rotary spraying.

Furthermore, a conveying tube 4, provided in the body 1, is provided at one end with a fluid container inlet 41 connecting with the fluid container 12 and the other end with a contained fluid outlet 42 which is disposed within the fluid tube 2 and extends to the spraying outlet 22 of the fluid tube 2. When fluid F1 is sprayed out from the spraying outlet 22 of the fluid tube 2, Venturi effect is induced, which effectively makes a contained fluid F2 in a container 12 being sprayed from the conveying tube 4.

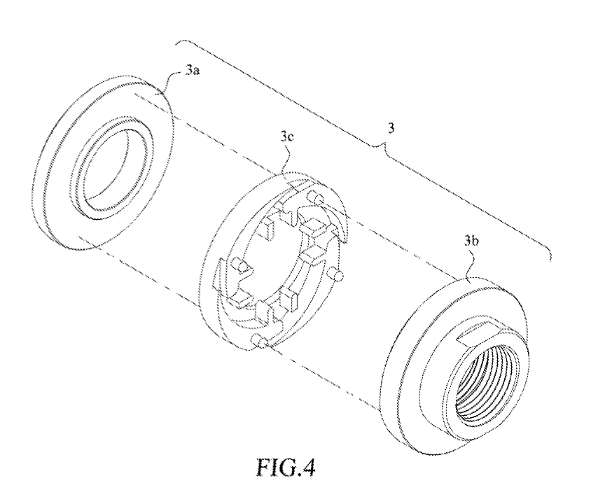

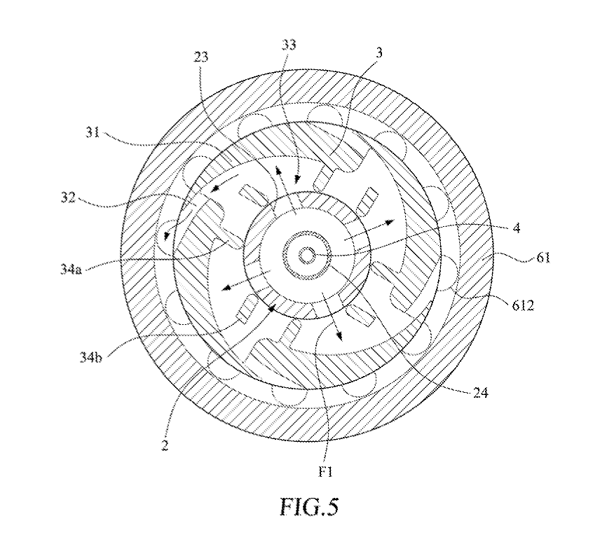

Please further refer to FIGS. 4 and 5. FIG. 4 is a perspective view illustrating a rotary means and FIG. 5 is a cross-section view of the rotary means. The rotary means 3 in this embodiment includes a front fastening layer 3a, a back fastening layer 3b, and a flow channel layer 3c disposed therebetween. Because the front fastening layer 3a and the back fastening layer 3b have a simple configuration, both of them may be made of a rigid material such as a metal material, an acrylic resin material, or the like. The flow channel layer 3c has a complex configuration so it is preferred to be made of a plastic material such as a plastic, a rubber, or the like. By such way in material selection, it makes the rotary means 3 being easy in manufacture. However, the present invention is not limited to this, and the flow channel layer 3c may be made of a rigid material as well.

The rotary means 3 is coupled with the fluid tube 2. A plurality of through holes 23 are provided on tube wall of the fluid tube 2 for connecting with the rotary means 3. Further, the fluid tube 2 is also provided inside with a splitter 24. The splitter 24, which is a tube in this embodiment, is disposed inside the fluid tube 2 for splitting the fluid tube 2 into two sections, and thus the fluid F1 will be split into two portions when flowing through the splitter 24. One portion of the fluid F1 flows to the spraying outlet 22 of the fluid tube 2 through the section adjacent to inside of the splitter 24, and the other portion of the fluid F1 flows to the through holes 23 of the fluid tube 2 through the section adjacent to outside of the splitter 24 and then flows into the rotary means 3 from the through holes 23.

The rotary means 3 is provided with a drive wall 31 inclining to a fluid output direction of the through hole 23 and an outflow passage 32 formed at an end of the drive wall 31. The fluid F1, which flows into the rotary means 3 through the through holes 23, flows through a flow space 33 to push the drive wall 31 and then flows out from the rotary means 3 through the outflow passage 32. During the above process, the drive wall 31 is driven and pushed by a force of the fluid F1 output from the through holes 23, so as to make the rotary means 3 rotating and also make the fluid tube 2 rotating with the rotary means 3.

Rotating direction of the rotary means 3 corresponds to an inclining direction of the drive wall 31. In this embodiment, the drive wall 31 is formed extending along an involute curve as illustrated in FIG. 5, so that the rotating direction of the rotary means 3 is a clockwise direction.

Note that although the number of the drive wall 31 in this embodiment is four, the present invention is not limited to this, and the number of the drive wall 31 can be one. In this case, the outflow passage 32 is formed between a front end and a rear end of the drive wall 31.

In addition, the rotary means 3 is provided with a plurality of fastening ribs 34a and 34b extending toward the fluid tube 2, which the fastening ribs 34a and 34b is used for fastening the fluid tube 2 to a rotary center of the rotary means 3 so as to decrease yaw error in rotation.

With the structure disclosed in the present invention, the fluid tube 2 can be rotated without power supplying. The rotary means 3 is stronger in structure and is easy in miniaturizing because the drive wall 31, the outflow passage 32, the flow space 33 and so on are formed inside the rotary means 3. Further, the rotary means 3 having such structure can be stable in rotating and rotate uniformly in high speed with low variation.

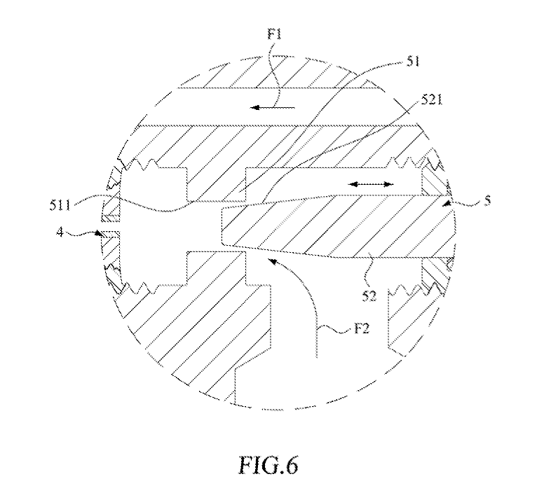

Please further refer to FIG. 6, which is a cross-section view of a flow rate regulating means. In this embodiment, the conveying tube 4 is further provided inside with a flow rate regulating means 5 in order to regulate flow rate of the fluid F2 conveyed through the conveying tube 4. The flow rate regulating means 5 includes a water stopper 51, a seal member 52, and a regulating member 53 (see FIG. 2). The water stopper 51 is formed with a flow hole 511 through which the fluid F2 in the conveying tube 4 can pass. The seal member 52 is formed at one end thereof with a sharp section 521 movably disposed in the flow hole 511 of the water stopper 51 and the other end thereof extending out of the body 1 to assemble with the regulating member 53 (see FIG. 2). Depth of the sharp section 521 of the seal member 52 being located in the flow hole 511 of the water stopper 51 can be adjusted by the regulating member 53, so that by changing the size of the gap between the flow hole 511 and the sharp section 521, the flow rate of the fluid F2 which flows through the conveying tube 4 is regulated.

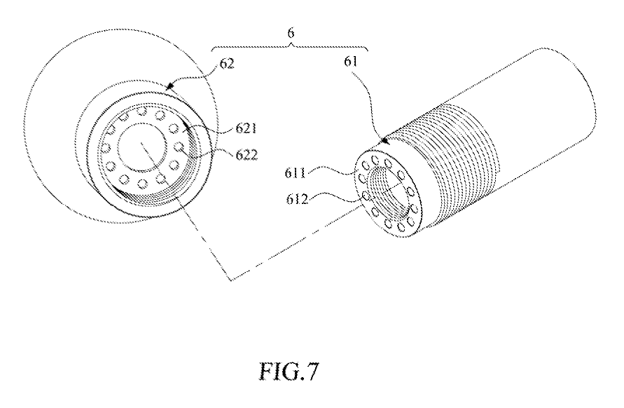

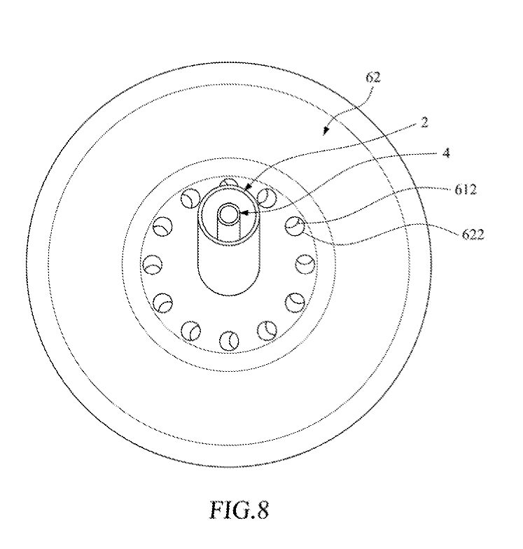

Please further refer to FIGS. 7 and 8. FIG. 7 is a perspective view illustrating a rotation speed adjusting means and FIG. 8 is another perspective view illustrating the rotation speed adjusting means. The rotary spraying device 100 is further provided with a rotation speed adjusting means 6 in order to adjust rotation speed of the fluid tube 2 and the rotary means 3. The rotation speed adjusting means 6 include a first adjusting member 61 and a second adjusting member 62. The first adjusting member 61 is connected with the outflow passage 32 of the rotary means 3 and has an outlet surface 611 formed with a plurality of first openings 612. Therefore, the fluid F1 output from the rotary means 3 will flow into the first adjusting member 61 and then output from the first openings 612. The second adjusting member 62 has an inlet surface 621 formed with a plurality of second openings 622 corresponding to the first openings 612. The inlet surface 621 of the second adjusting member 62 is coupled with the outlet surface 611 of the first adjusting member 61 to rotate with first adjusting member 61. With such structure, size of a connecting cavity of the first openings 612 and the second openings 622 can be changed by the relative rotation between the first adjusting member 61 and the second adjusting member 62. Thus, the flow rate of the fluid F1 output from the rotary means 3 can be adjusted, and the rotation speed of the rotary means 3 is determined based on the flow rate of fluid F1.

As can be appreciated from the above embodiments, the rotary spraying device of the present invention has industry worth which meets the requirement for a patent. The above description should be considered as only the discussion of the preferred embodiments of the present invention. However, a person having ordinary skill in the art may make various modifications to the present invention. Those modifications still fall within the spirit and scope defined by the appended claims.

What is claimed is:

1. A rotary spraying device comprising:
a fluid tube provided at one end thereof with a fluid inlet and the other end thereof with a spraying outlet, and a through hole provided on tube wall of the fluid tube;
a rotary means, coupled with the fluid tube, provided with a drive wall inclining to a fluid output direction of the through hole and an outflow passage formed at an end of the drive wall, where the drive wall is driven and pushed by a force of fluid output from the through hole via a fluid connection by a flow space; and
a conveying tube provided at one end thereof with a fluid container inlet for connecting to a fluid container, and the other end thereof being disposed within the fluid tube to extend to the spraying outlet of the fluid tube,
wherein a portion of a fluid, which flows in the fluid tube from the fluid inlet, flows into the rotary means through the through hole, and thus the rotary means is rotated by an applying force applied to the drive wall by the fluid, and it thus drive a rotation of the fluid tube for processing rotary spraying.

2. The rotary spraying device as claimed in claim 1, wherein the drive wall of the rotary means is formed extending along an involute curve.

3. The rotary spraying device as claimed in claim 1, wherein the rotary means is further provided with a plurality of fastening ribs extending toward the fluid tube.

4. The rotary spraying device as claimed in claim 1, wherein the rotary means includes a front fastening layer, a back fastening layer, and a flow channel layer disposed therebetween.

5. The rotary spraying device as claimed in claim 4, wherein the front fastening layer and the back fastening layer are made of a rigid material and the flow channel layer is made of a plastic material.

6. The rotary spraying device as claimed in claim 1, wherein the fluid tube is further provided inside with a splitter for splitting the fluid flowing through the fluid tube into two portion, wherein one portion of the fluid flows toward the spraying outlet of the fluid tube and the other portion of the fluid flows toward the through hole of the fluid tube.

7. The rotary spraying device as claimed in claim 1, wherein the conveying tube is further provided inside with a flow rate regulating means including a water stopper and a seal member, the water stopper is formed with a flow hole and the seal member is formed at one end thereof with a sharp section movably disposed in the flow hole of the water stopper.

8. The rotary spraying device as claimed in claim 1, further comprising a rotation speed adjusting means including a first adjusting member and a second adjusting member, wherein the first adjusting member is connected with the outflow passage of the rotary means and has an outlet surface formed with a plurality of first openings and the second adjusting member has an inlet surface coupled with the outlet surface of the first adjusting member to rotate with first adjusting member, and the inlet surface is formed with a plurality of second openings corresponding to the first openings.
